(19) United States
(12) Patent Application Publication
(10) Pub. No.: US 2023/0191290 A1
(43) Pub. Date: Jun. 22, 2023

(54) SYSTEMS AND METHODS FOR RECYCLING RECOVERED WATER UTILIZING A DEFLUIDIZING TANK

(71) Applicant: 360 RESEARCH LABS, LLC, Midland, TX (US)

(72) Inventors: Tim MARCO, Galveston, TX (US); Robert ARIMOND, Magnolia, TX (US); John MABEE, Midland, TX (US)

(73) Assignee: 360 RESEARCH LABS, LLC, Midland, TX (US)

(21) Appl. No.: 17/557,999

(22) Filed: Dec. 21, 2021

(51) Int. Cl. B01D 29/11; B01D 29/52; B01D 21/00; E21B 43/34

(52) U.S. Cl. CPC B01D 29/114; B01D 29/52; B01D 21/0039; E21B 43/35; B01D 2201/043; B01D 2221/04

(57) ABSTRACT

Defluidizing tanks may include a tank having an interior defined by side walls and a bottom; a filter assembly emplaced within the interior of the tank and constructed to receive a slurry of solids and recovered fluid; and a weir chamber within the tank and defined by the interior of the tank and at least one wall of the filter assembly. Systems may include a source of recovered fluid from a wellbore operation; a filtration unit receiving the recovered fluid and isolating a fraction of solids from the recovered fluid, the filtration unit having a backflush mode in which the fraction of solids is evacuated from the filtration unit; and a defluidizing tank receiving the evacuated fraction of solids to generate a filtrate and dried solids.

### FIELD OF THE INVENTION

The presently disclosed subject matter relates to systems and methods of recycling recovered fluids collected from wellbore operations.

### BACKGROUND OF THE INVENTION

During hydrocarbon exploration and recovery, water and other aqueous fluids are employed for various wellbore operations including drilling, completions, injection, fracturing, and the like, which can amount to a demand for hundreds of thousands of gallons or more. Water and other fluids are often supplied through tanker trucks or pipeline that are delivered to the well site, and formulated with various additives according to use. As well operations are conducted, wellbore fluids are recovered at the surface as flowback and/or production fluids.

Recovered fluids must be managed according to various local government regulations that often involve transporting the recovered fluids to a designated processing facility, which incurs substantial operating costs in terms of fuel, time, and equipment. Recovered fluids may be a complex mixture of aqueous and nonaqueous fluids, gases, solids, and chemical contaminants that can vary in concentration depending on the composition of the wellbore fluid, additives used, and formation characteristics. Recycling recovered fluids typically involves the separation of the fluid into its constituent components for disposal along specified guidelines and/or reuse in related applications.

### SUMMARY OF THE INVENTION

The presently disclosed subject matter relates to systems and methods of recycling recovered fluids that utilize defluidizing tanks to enhance yield.

In an aspect, the present disclosure is directed to defluidizing tanks that include a tank having an interior defined by side walls and a bottom; a filter assembly emplaced within the interior of the tank and constructed to receive a slurry of solids and recovered fluid; a weir chamber within the tank and defined by the interior of the tank and at least one wall of the filter assembly; a solids drain in fluid connection with the interior of the filter assembly and passing through a side wall of the tank; a liquid drain in fluid connection with the weir chamber and passing through a side wall of the tank.

In another aspect, the present disclosure is directed to systems that include a source of recovered fluid from a wellbore operation; a filtration unit receiving the recovered fluid and isolating a fraction of solids from the recovered fluid, the filtration unit having a backflush mode in which the fraction of solids is evacuated from the filtration unit; and a defluidizing tank receiving the evacuated fraction of solids to generate a filtrate and dried solids.

In another aspect, the present disclosure is directed to methods that include filtering a recovered fluid in a filtration unit to remove a fraction of solids; backflushing the fraction of solids from the filtration unit to a defluidizing tank; and dewatering the fraction of solids and collecting a reduced solids filtrate.

### BRIEF DESCRIPTION OF THE DRAWINGS

FIG. 1 is a schematic flowchart of a method of recycling recovered fluids in accordance with the present disclosure.

FIG. 2 is an isometric view of a defluidizing tank in accordance with the present disclosure.

FIG. 3 is an overhead plan view of a defluidizing tank in accordance with the present disclosure.

FIG. 4 is an end view of a defluidizing tank in accordance with the present disclosure.

FIG. 5 is an end plan view of a defluidizing tank in accordance with the present disclosure.

### DETAILED DESCRIPTION OF THE INVENTION

The present disclosure is directed to methods and systems of recycling of recovered fluids collected from wellbore operations. Particularly, systems may include one or more defluidizing tanks that extract fluids from solids retained by a filtration unit. Methods disclosed herein may also include the use of defluidizing tanks to enhance fluid recovery during recycle of recovered fluids.

Fluids recovered from wellbore operations are often processed prior to reuse or disposal by a number of techniques. Recycling recovered fluids (including aqueous fluids such as water and/or brines) may involve separation and purification of various components to comply with regulations, to make components marketable, and/or to minimize weight and transportation costs. Particularly, methods of recycling recovered fluids disclosed herein enhance fluid retention and minimize loss associated with disposing solids retained by a filtration unit through the use of one or more defluidizing tanks.

Methods and systems disclosed herein may include closed loop processes for recycling recovered fluids that include one or more defluidizing tanks. Recycling methods may be continuous and may incorporate one or more units or components that are isolated (through the use of manual or automated valves, for example) from an active process for performance adjustment, maintenance, or repair. For example, a filtration unit may converted from an active filtration mode to a backflush/backwash mode in which accumulated solids are directed out of the filtration unit to a defluidizing tank. Systems utilized for recycling recovered fluids disclosed herein may include a number of stages (or equipment units) having different functions such as chemical treatments, demulsification, fractionation of phases, degassing, decreasing and/or removing solids, removal of radioactive materials desalination, disinfection, softening, and the like.

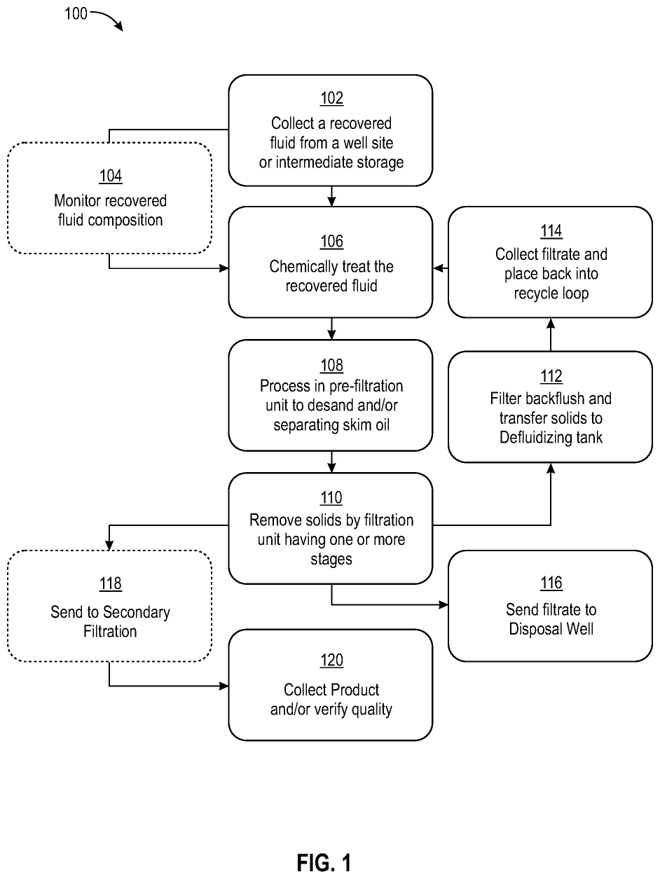

FIG. 1 is a flowchart depicting an example process 100 for cleaning and/or recycling a recovered fluid. Recycling methods may proceed at 102 by collecting a recovered fluid from a suitable location such as flowback stream from a well or from an intermediate storage (e.g., holding tanks, pits, wells, or other sources). Collection may involve any suitable technique known in the art including pumping, decanting, siphoning, roll off, and the like. The type and composition of the recovered fluid is not considered particularly limiting and may include a production fluid, a spent fracturing fluid, an injection fluid, a spent drilling fluid, a spent completions fluid, a fluid recovered from a municipality and/or a well, and the like, and combinations thereof. A ‘spent’ fluid refers to a particular fluid that has already performed its function within a subterranean reservoir wellbore and has been flowed back to the surface of the wellbore. The recovered fluid may be a liquid, but can also encompass fluids containing various fractions of gas and/or solids.

Following collection at 102, recovered fluid composition may optionally be monitored at 104. Monitoring at 104 may include analyzing various system fluid properties may include fluid composition, oxidation reduction potential (ORP), metal ion concentration, soluble organic concentration, total suspended solids, total dissolved solids, saline concentration, additive concentration, hydrocarbon (fluid and gas) concentration and pressure (e.g., methane concentration and pressure), and the like. Methods may include monitoring one or more properties of the fluid and modifying steps of the recycling process in response, for example, to increase efficiency, adjust chemical treatment additions by amount or type enhance the removal (or survival) or chemicals and/or solids in the recovered fluid, adjust and service system components, and the like. Monitoring may involve analyzing recovered fluid composition in real-time or at various intervals, such as by the minute, hour, day, and the like.

Monitoring systems used in step 104 may include any suitable sampling mechanism, including an in-line sensor (or array), pressure gauges, sampling ports, collection container, and the like. Relevant fluid properties that may be monitored include fluid volume, pressure, pressure drop, water velocity, temperature, changes in flow rate, maximum and minimum flow speeds, and other flow characteristics. Sensors disclosed herein may also include sensors that monitor pressure and fluid composition that may indicate fluid loss, fluid intrusion, deterioration of the wellbore casing, failure of system components within the well, and the like.

The monitoring system uses sensors designed to collect information about the chemical composition as well as the solids content; these sensors then convey this information to the chemical treatment 106 and filtration 110 stages. For instance, if a large concentration of metal ions is present, the sensors detect elevated levels and alert the chemical addition stage as to what and how much to put into the water to treat this component. If the sensors identify a large concentration of large solids, then the flow rate and/or number of filtration stages can be adjusted.

Recovered fluids from 102 may be chemically treated at 106 to modify the concentration of various fluid components (or contaminants), such as calcium, magnesium, barium, iron (e.g., Fe², Fe³⁺), manganese, as well as hydrocarbons, sulfur, hydrogen disulfide, sulfates, total organic carbon, total dissolved solids, volatile organic compounds, and bacterial contamination. Chemical treatments can be employed using one or more injector pumps (solid and/or liquid) at any location in the recycle process, such as following recovery at 102, prior to filtration, following filtration, or any combination thereof. Suitable chemical treatments may include oxidizers such as ozone, peroxide, permanganate, oxygen, chlorine, chlorine dioxide, and the like; demulsifiers; flocculants; coagulants; and the like.

The chemical treatment at 106 may be tailored based on a number of fluid properties, such as those described above with respect to monitoring at 104, with consideration to factors such as end use or regulatory requirements. For example, if the recovered fluid is a drilling fluid, the recycling method may be tailored to retain certain fluid additives (e.g., brines, antioxidants, hydration inhibitors, and the like) to minimize the chemical additions needed prior to reuse.

Recycle methods disclosed herein may include one or more separation processes at 108 in a pre-filtration unit that may include a desanding module for the removal of large particles, a degassing module, and/or a skim tank module (e.g., gun barrel, HWSB tank) for the separation of non-aqueous fluids and skim oils. Fluid separation at 108 may also involve chemical treatments from 106, such as demulsifiers, to enhance phase separation and enable the removal of non-aqueous components from aqueous recovered fluids.

After pre-filtration at 108, recovered fluids are transferred to a filtration unit at 110 that functions to remove solids, coagulated metals, organics, gases, and the like. The filtration unit at 110 may operate in a closed-loop manner, where ‘closed-loop’ refers to filtering of the fluid in a repeatable cycle until the properties of the recovered fluid are within the desired specification, such as based on the end use or applicable regulations, including environmental, social, and governance (ESG) recycle ratings.

Filtration units may contain one or more filtration modules and may include the use of multiple filtration methods and/or media (e.g., sand, gravel, anthracite, walnut shell, ion exchange technology, and the like). Filtration units may also incorporate settling tanks, evaporation ponds, gas flotation systems, and the like. Media-based filtration units may include coarse and/or fine filtration modules. Coarse filtration modules may be capable of removing about 97% of solids, such as coagulated metals, oil solids, and drilling solids. Fine filtration modules may include the use of micron filters having size ratings in a range of about 5 μm to about 100 μm.

Filtration units at 110 may include one or more filtration modules operating in parallel, in series, or combinations thereof. ‘In parallel’ is defined herein as flowing a fluid through two or more filter components at about the same time, regardless of the flow rate into each filter component. ‘In series’ is defined herein as flowing a fluid through each filter component in a consecutive manner. Parallel operation may be desirable, for example, in applications requiring increased throughput.

The overall filtration unit contact time for a recovered fluid may vary depending on the contaminant level of the recovered fluid and the target product fluid composition, but may vary from about 10 minutes, about 15 minutes, or about 20 minutes. Filtration units at 110 may include one or more filter components that filter a fluid at a rate ranging from about 1 barrel independently to about 65 barrels of recovered fluid per minute, alternatively from about 5 barrels independently to about 55 barrels of recovered fluid per minute, or from about 10 barrels independently to about 40 barrels of recovered fluid per minute in another non-limiting embodiment. A barrel is about 42 gallons of fluid.

Filter components may be monitored for pressure increase that indicates fouling and/or may be serviced on a schedule. For example, monitoring at 104 may also include analyzing occlusion rates of the filtration components to determine when cleaning is required. Once fouling is detected in one or more filtration modules, the filtration modules may be backflushed at 118 and retained solids may be directed to disposal or a defluidizing tank to recover excess fluids.

The filtration unit at 110 may also include at least one self-cleaning filter component in which the filter component includes a mechanism that cleans the filter component without direction or input by an operator, and/or without stopping the overall function of the filtration unit. For example, a non-limiting example of a self-cleaning mechanism is one that is initiated once the pressure within the filter component reaches a pre-determined threshold, and a signal may be sent to the self-cleaning mechanism to begin cleaning the interior of the filter component. In a non-limiting embodiment, the self-cleaning mechanism may be or include a scraping device, a brushing device, a suction device, and combinations thereof.

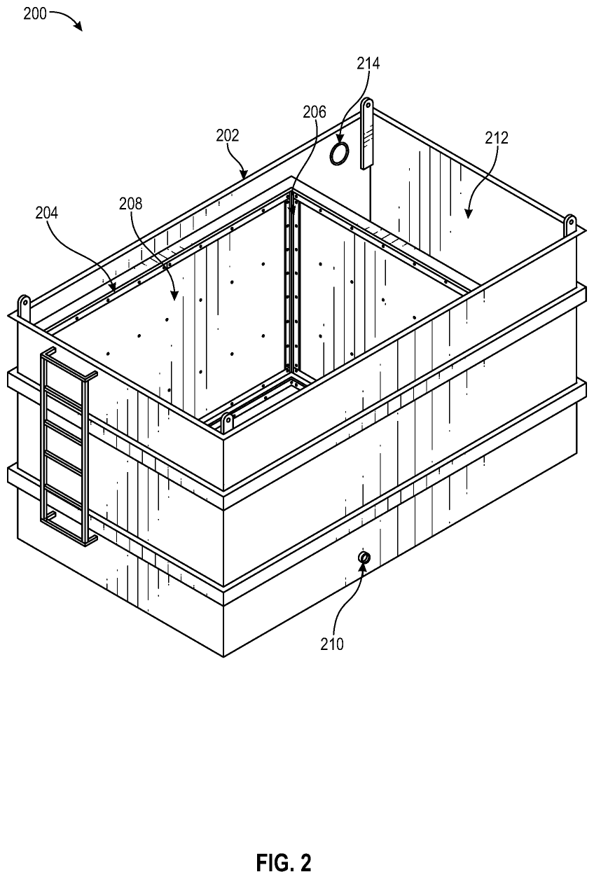

Retained solids backflushed from the filtration unit at 110 may be processed by a defluidizing unit at 118 that contains one or more defluidizing tanks. Defluidizing tanks disclosed herein may enhance recovered fluid yield by extracting commingled fluids that are normally lost during disposal of the retained solids from filtration unit 110 (e.g., sediment, drill cuttings, flocculated metals). An example of an embodiment of a defluidizing tank 200 is shown in FIG. 2. Defluidizing tank includes an exterior tank 202 tank having an interior defined by side walls and a bottom.

The exterior tank 202 forms an interior that accepts a filter assembly 204 into which retained solids from filtration unit 110 (in a slurry form, for example) are deposited for defluidization in which excess fluids to pass into the exterior tank 202 as a filtrate. Filter assembly 204 includes an assembly frame 206 to which a plurality of filter panels 208 are attached and define a filtration surface area. Attachment of the filter panels 208 to the assembly frame 206 may include the use of any suitable hardware known in the art, such as retaining rings, gaskets, liners, and the like.

Filter panels 208 may be constructed from a filtration medium having an effective mesh size dependent on the size and quantity of the filtered solids, such as that expected based on a compositional analysis at 104 or 106. In some embodiments, the mesh size may range from about 10 μm to about 1 mm, about 40 μm to about 500 μm, about 50 μm to about 400 μm, or about 50 μm to about 150 μm. Filter panels 208 may be formed from any suitable filtration medium (or mediums) and may be resistant to corrosive materials and high ionic strength liquids that are often present in recovered fluids. In some embodiments, filter panels may include a filter medium constructed from plastics such as nylon, polyester, polypropylene, and the like; metals such as carbon steels, stainless steels, and the like; aramid; fiberglass; ceramics; mixed mediums; and the like. In some embodiments, one or more of the assembly frame 206 and the filter panels 208 may be constructed from 316 stainless steel.

Collected solids retained in filter assembly 204 may be evacuated from the defluidizing tank 200 by solids drain 210 passing through a wall of the exterior tank 202. Solids evacuation may be done by any suitable method, including gravity, pumping, washing, and the like. Solids obtained (typically as a thickened slurry) are placed into a suitable transport and directed to disposal or resale. When fouling is detected, cleaning of the filter panel 208 medium may be done by any suitable technique, including pressure washing, scrubbing, degreasing, use of surfactants and/or solvents, and the like.

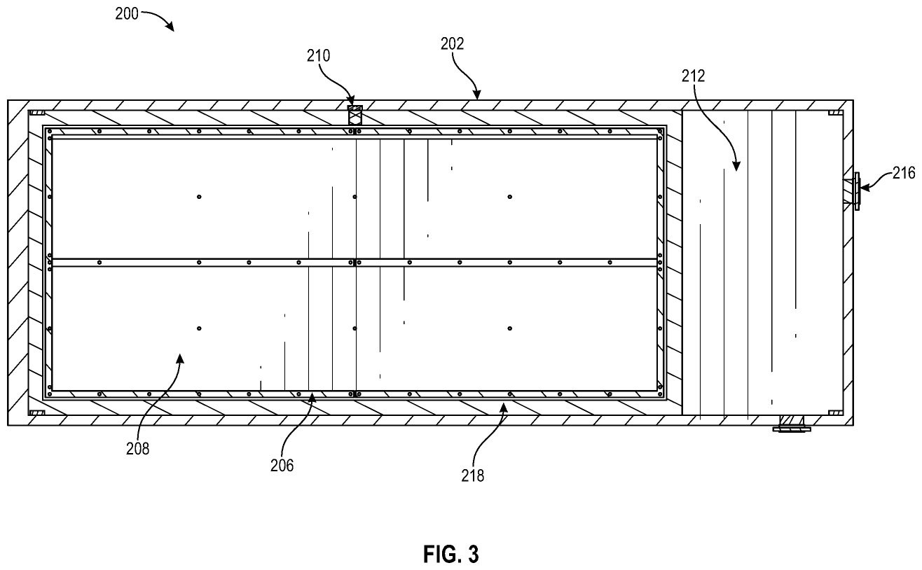

With particular respect to FIG. 3, a bottom plan view of defluidizing tank 200 is shown. The interior of tank 202 and the exterior of the filter assembly 204 defines a weir chamber 212 into which filtrate collects. In addition, the filter assembly 204 includes a standoff from the sides and bottom that forms a defluidizing zone 218, which includes a void volume into which filtrate extracted from the solids in filter assembly 204 collects and is directed to the weir chamber 212. A filtrate drain 216 in fluid connection with and/or located in the weir chamber 212 (or any suitable location) allows fluids to the evacuated for reuse, disposal, or recycle through a side wall of the exterior tank 202. The filtrate may be evacuated from the defluidizing tank 200 by gravity or pump assistance. Defluidizing tank 200 may also include an overflow drain 214 to minimize backflow into the filter assembly 204. In some embodiments, evacuation of filtrate may also be done by a manual or pumped diptube, submersible or bilge pump, and the like.

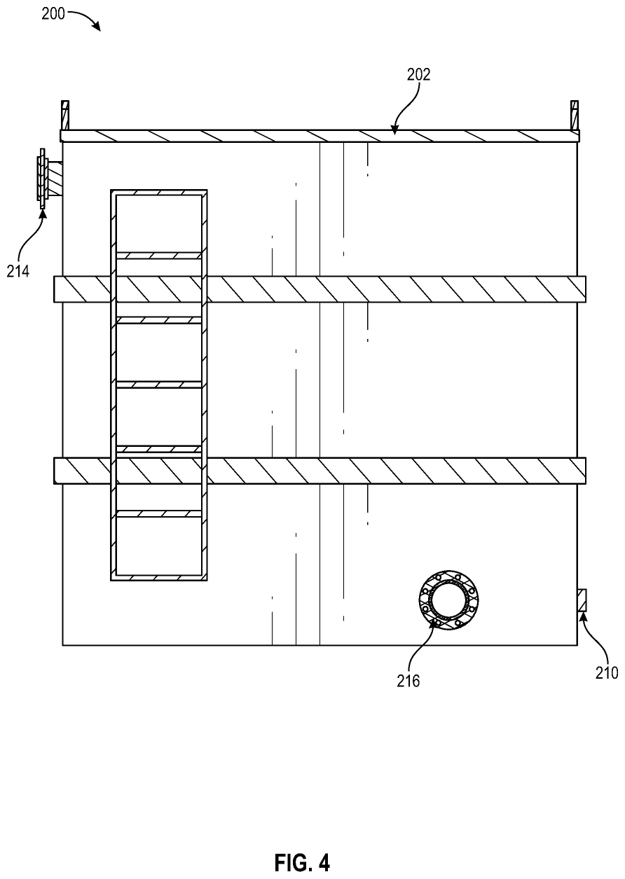

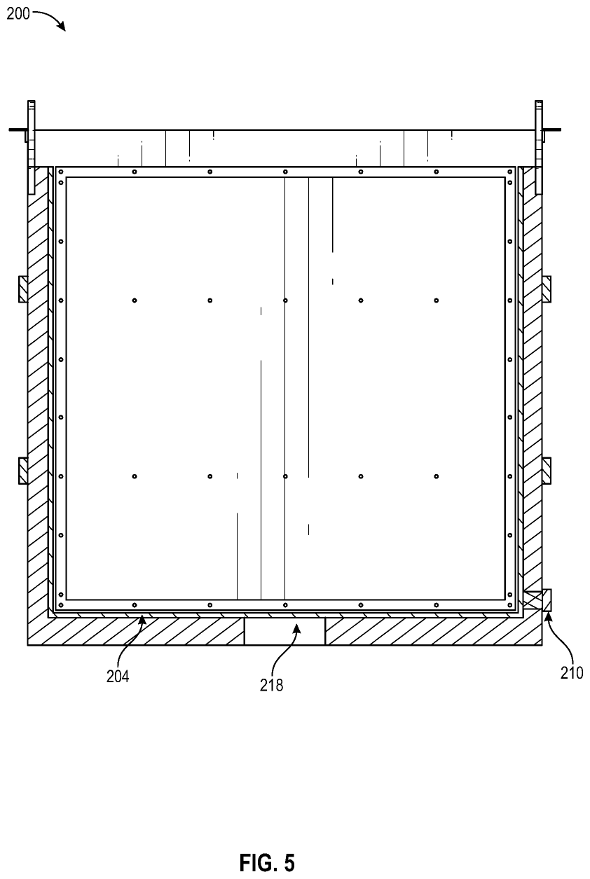

An alternate rear view of the defluidizing tank 200 is shown in FIG. 4, which highlights a possible placement of the solids drain 210 and the filtrate drain 216 through the exterior tank 202. A rear plan view of the defluidizing tank 200 is shown in FIG. 5, which illustrates the defluidizing zone 218 defined between exterior tank 202 and the filter assembly 204. The passage of the solids drain 210 through the exterior tank 202 is also shown.

Returning to FIG. 1, the filtrate collected at 114 (such as from filtrate drain 216 in FIG. 3) may be treated separately by any suitable process, or recombined within the method 100 at any point, including during chemical treatment at 106, filtration process at 110, or with recycled water at 120. The resulting defluidized solids from 112 may be collected and sold or disposed of as appropriate. The recycled fluid exiting filtration unit at 110 may be passed through a secondary filtration (depending on end use requirements), and collected at 120.

Recycled fluids may be reused for any suitable purpose in accordance with local regulatory requirements, including reinjection, reformulation in wellbore fluids, disposal in a salt water disposal (SWD) well, and the like. While the filtrate at 114 may be predominantly aqueous fluids, recycling methods may be tailored to minimize the removal of various soluble additives such as brines, antioxidants, bactericides, and other chemicals, which may minimize the need for chemical adjustments of the recycled fluid prior to reuse. For example, processes may be customized (e.g., modifying filtration media, chemical treatments, or omitting treatments) such that concentration of desirable additives is substantially unchanged or reduced.

Accordingly, methods disclosed herein include method of recycling recovered fluids that enhance overall recovery yield. Methods may minimize fresh water usage and minimize costs otherwise associated with process water disposal and transport. Wellbore fluid recycle may also reduce the cost estimates for fracking and other fluid-intensive operations, in addition to increasing the feasibility for well operations in remote and arid regions. Recycled fluids may be circulated into a subterranean reservoir wellbore during a hydrocarbon recovery operation, such as fracturing operations, injection operations, drilling operations, completions, and combinations thereof.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A defluidizing tank, comprising:
a tank having an interior defined by side walls and a bottom;
a filter assembly emplaced within the interior of the tank and constructed to receive a slurry of solids and recovered fluid;
a weir chamber within the tank and defined by the interior of the tank and at least one wall of the filter assembly;
a solids drain in fluid connection with the interior of the filter assembly and passing through a side wall of the tank;
a liquid drain in fluid connection with the weir chamber and passing through a side wall of the tank.

2. The defluidizing tank of claim 1, wherein the weir chamber is about 5% or more of the total volume of the interior of the tank.

3. The defluidizing tank of claim 1, further comprising an overflow valve in fluid communication with the weir chamber.

4. The defluidizing tank of claim 1, wherein the filter assembly comprises a frame fitted with a plurality of filter plates.

5. A system, comprising:
a source of recovered fluid from a wellbore operation;
a filtration unit receiving the recovered fluid and isolating a fraction of solids from the recovered fluid, the filtration unit having a backflush mode in which the fraction of solids is evacuated from the filtration unit; and
a defluidizing tank receiving the evacuated fraction of solids to generate a filtrate and dried solids.

6. The system of claim 5, wherein the defluidizing tank comprises a fluid connection to the filtration unit for transferring the filtrate.

7. The system of claim 5, wherein the filtration unit comprises a desanding module.

8. The system of claim 5, wherein the defluidizing tank comprises:
a tank having an interior defined by side walls and a bottom;
a filter assembly emplaced within the interior of the tank and constructed to receive a slurry of solids and recovered fluid;
a weir chamber within the tank and defined by the interior of the tank and at least one wall of the filter assembly;
a solids drain in fluid connection with the interior of the filter assembly and passing through a side wall of the tank;
a liquid drain in fluid connection with the weir chamber and passing through a side wall of the tank.

9. The system of claim 8, wherein the weir chamber is about 5% or more of the total volume of the interior of the tank.

10. The system of claim 8, wherein the defluidizing tank comprises a pump fluidly connected to the liquid drain for driving fluids out of the weir chamber.

11. The system of claim 8, further comprising an overflow valve in fluid communication with the weir chamber.

12. The system of claim 8, wherein the filter assembly comprises a frame fitted with a plurality of filter plates.

13. A method, comprising:
filtering a recovered fluid in a filtration unit to remove a fraction of solids;
backflushing the fraction of solids from the filtration unit to a defluidizing tank; and
dewatering the fraction of solids and collecting a reduced solids filtrate.

14. The method of claim 13, further comprising transferring the reduced solids filtrate back to the filtration unit.

15. The method of claim 13, wherein the filtrate is chemically treated prior to transfer to the filtration unit.

16. The method of claim 13, wherein the filtration unit comprises a desanding module.

17. The method of claim 13, wherein the defluidizing tank comprises:
a tank having an interior defined by side walls and a bottom;
a filter assembly emplaced within the interior of the tank and constructed to receive a slurry of solids and recovered fluid;
a weir chamber within the tank and defined by the interior of the tank and at least one wall of the filter assembly;
a solids drain in fluid connection with the interior of the filter assembly and passing through a side wall of the tank;
a liquid drain in fluid connection with the weir chamber and passing through a side wall of the tank.

18. The method of claim 17, wherein the weir chamber is about 5% or more of the total volume of the interior of the tank.

19. The method of claim 17, further comprising an overflow valve in fluid communication with the weir chamber.

20. The method of claim 17, wherein the filter assembly comprises a frame fitted with a plurality of filter plates.
